(19) United States
(12) Patent Application Publication
(10) Pub. No.: US 2020/0130992 A1
(43) Pub. Date: Apr. 30, 2020

(54) PASSENGER SELECTION FOR INTERRUPTED ELEVATOR SERVICE

(71) Applicant: Otis Elevator Company, Farmington, CT (US)

(72) Inventors: Paul A. Simcik, Southington, CT (US); Bradley Armand Scoville, Farmington, CT (US); Harrison Daniels, Avon, CT (US)

(21) Appl. No.: 16/169,021

(22) Filed: Oct. 24, 2018

(51) Int. Cl. B66B 1/46; B66B 1/24; B66B 1/34; B66B 5/00; B66B 5/02

(52) U.S. Cl. CPC B66B 1/468; B66B 1/2458; B66B 1/3461; B66B 5/0018; B66B 2201/233; B66B 2201/103; B66B 2201/104; B66B 2201/23; B66B 5/02

(57) ABSTRACT

A method of reassigning an elevator call for an elevator car comprising: receiving an elevator call from a mobile device, the elevator call comprising a destination request to travel to a destination floor; assigning a first elevator car to the elevator call; determining that the first elevator car cannot serve the elevator call; activating an alert on the mobile device to enter any elevator car; detecting whether the mobile device enters a second elevator car; and assigning the second elevator car to the elevator call.

### BACKGROUND

The subject matter disclosed herein generally relates to the field of elevator systems, and more particularly to an apparatus and method for calling elevator cars within the elevator system.

Existing elevator systems allow a user to submit an elevator call (e.g., a hall call or a destination call) using their own mobile device (e.g., a smartphone).

### BRIEF SUMMARY

According to one embodiment, a method of reassigning an elevator call for an elevator car is provided. The method including: receiving an elevator call from a mobile device, the elevator call including a destination request to travel to a destination floor; assigning a first elevator car to the elevator call; determining that the first elevator car cannot serve the elevator call; activating an alert on the mobile device to enter any elevator car; detecting whether the mobile device enters a second elevator car; and assigning the second elevator car to the elevator call.

In addition to one or more of the features described above, or as an alternative, further embodiments may include that prior to determining that the first elevator car cannot serve the elevator call, the method further includes: activating an alert on the mobile device that the first elevator car has been assigned to the elevator call.

In addition to one or more of the features described above, or as an alternative, further embodiments may include that the detecting further includes: connecting to the mobile device using at least one of Wi-Fi and Bluetooth; and determining a distance between the second elevator car and the mobile device.

In addition to one or more of the features described above, or as an alternative, further embodiments may include that the detecting further includes: detecting a wireless signal of the mobile device, wherein the sensor does not connect to the wireless signal; and determining a distance between the second elevator car and the mobile device.

In addition to one or more of the features described above, or as an alternative, further embodiments may include that the detecting further includes: detecting a beacon transmitted by a sensor proximate the second elevator car using the mobile device; and determining a distance between the second elevator car and the mobile device in response to a strength of the beacon.

In addition to one or more of the features described above, or as an alternative, further embodiments may include: moving the second elevator car to the destination floor.

In addition to one or more of the features described above, or as an alternative, further embodiments may include: determining a boarding floor where the mobile device enters the second elevator car.

In addition to one or more of the features described above, or as an alternative, further embodiments may include that determining a boarding floor where the mobile device enters the second elevator car further includes: receiving a boarding floor from a selection input via the mobile device.

In addition to one or more of the features described above, or as an alternative, further embodiments may include that determining a boarding floor where the mobile device enters the second elevator car further includes: detecting a location of the mobile device when the mobile device enters the second elevator car.

In addition to one or more of the features described above, or as an alternative, further embodiments may include that the alert is a message displayed on the mobile device.

According to another embodiment, an elevator system is provided. The elevator system including: a first elevator car; a second elevator car; and a system controller including: a processor; and a memory including computer-executable instructions that, when executed by the processor, cause the processor to perform operations, the operations including: receiving an elevator call from a mobile device, the elevator call including a destination request to travel to a destination floor; assigning a first elevator car to the elevator call; determining that the first elevator car cannot serve the elevator call; activating an alert on the mobile device to enter any elevator car; detecting whether the mobile device enters a second elevator car; and assigning the second elevator car to the elevator call.

In addition to one or more of the features described above, or as an alternative, further embodiments may include that prior to determining that the first elevator car cannot serve the elevator call, the operations further includes: activating an alert on the mobile device that the first elevator car has been assigned to the elevator call.

In addition to one or more of the features described above, or as an alternative, further embodiments may include that the detecting further includes: connecting to the mobile device using at least one of Wi-Fi and Bluetooth; and determining a distance between the second elevator car and the mobile device.

In addition to one or more of the features described above, or as an alternative, further embodiments may include the detecting further includes: detecting a wireless signal of the mobile device, wherein the sensor does not connect to the wireless signal; and determining a distance between the second elevator car and the mobile device.

In addition to one or more of the features described above, or as an alternative, further embodiments may include that the detecting further includes: detecting a beacon transmitted by a sensor proximate the second elevator car using the mobile device; and determining a distance between the second elevator car and the mobile device in response to a strength of the beacon.

In addition to one or more of the features described above, or as an alternative, further embodiments may include that the operations further include: moving the second elevator car to the destination floor.

According to another embodiment, a computer program product tangibly embodied on a computer readable medium is provided. The computer program product including instructions that, when executed by a processor, cause the processor to perform operations including: receiving an elevator call from a mobile device, the elevator call including a destination request to travel to a destination floor; assigning a first elevator car to the elevator call; determining that the first elevator car cannot serve the elevator call; activating an alert on the mobile device to enter any elevator car; detecting whether the mobile device enters a second elevator car; and assigning the second elevator car to the elevator call.

In addition to one or more of the features described above, or as an alternative, further embodiments may include that prior to determining that the first elevator car cannot serve the elevator call, the operations further includes: activating an alert on the mobile device that the first elevator car has been assigned to the elevator call.

In addition to one or more of the features described above, or as an alternative, further embodiments may include that the detecting further includes: connecting to the mobile device using at least one of Wi-Fi and Bluetooth; and determining a distance between the second elevator car and the mobile device.

In addition to one or more of the features described above, or as an alternative, further embodiments may include that the detecting further includes: detecting a wireless signal of the mobile device, wherein the sensor does not connect to the wireless signal; and determining a distance between the second elevator car and the mobile device.

Technical effects of embodiments of the present disclosure include the ability for an elevator control system to receive elevator destination calls from a mobile device, detect if an assigned elevator car cannot serve the destination call, and then detect whether the mobile device boards the another elevator car.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

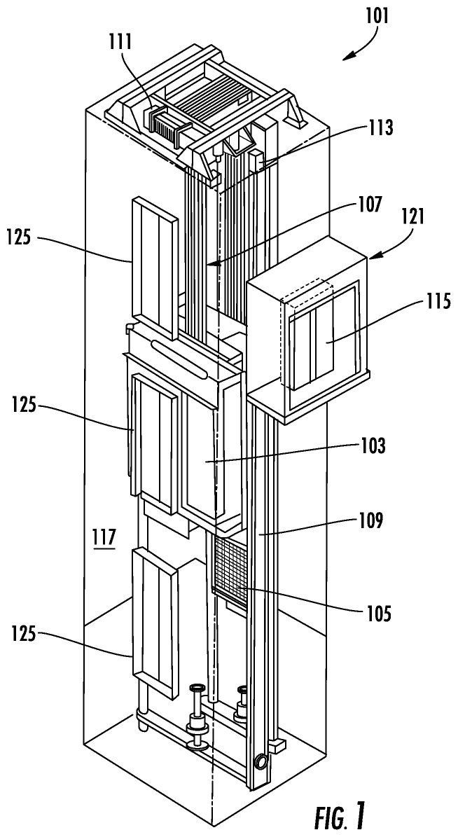

FIG. 1 is a schematic illustration of an elevator system that may employ various embodiments of the present disclosure;

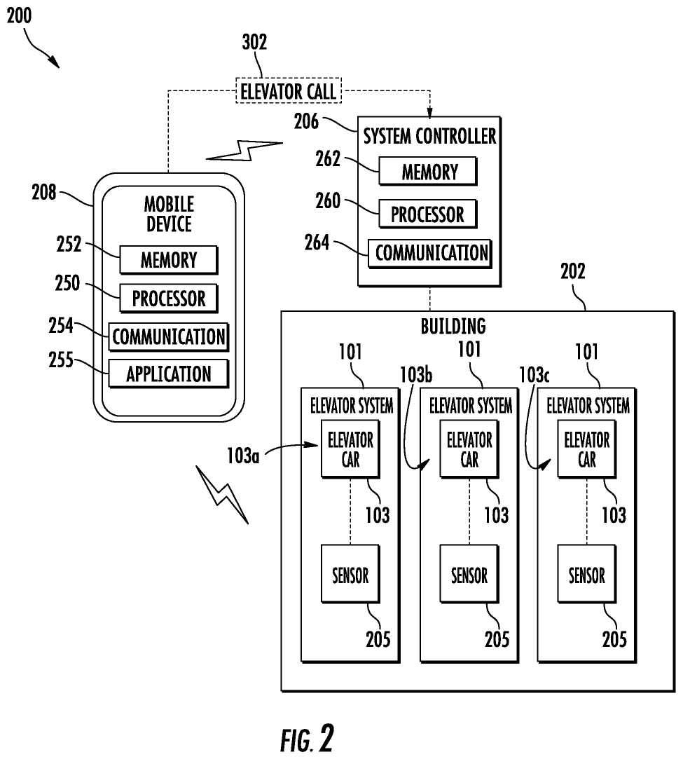

FIG. 2 illustrates a schematic view of an elevator call control system, in accordance with an embodiment of the disclosure;

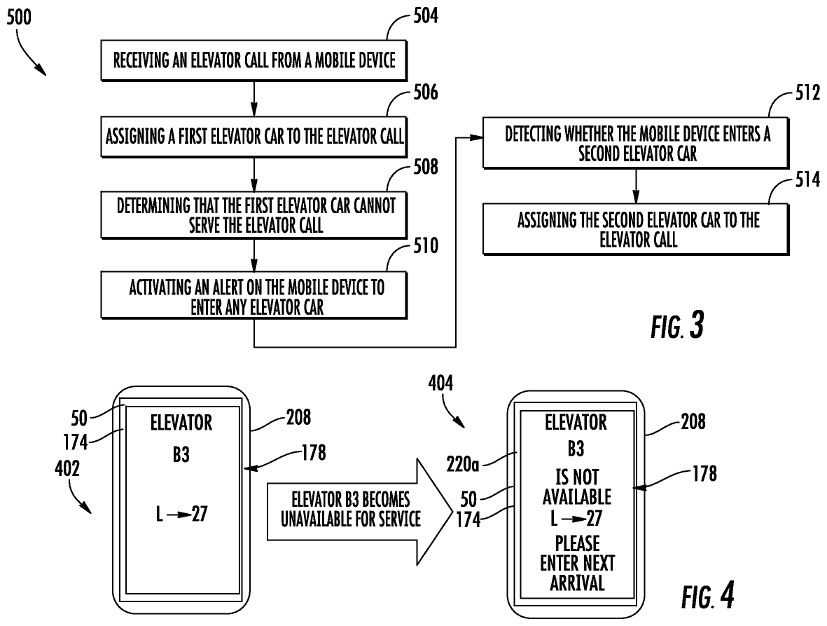

FIG. 3 is a flow diagram illustrating a method of reassigning an elevator call for an elevator car, according to an embodiment of the present disclosure; and

FIG. 4 illustrates a graphical user interface of a mobile device within the elevator call control system of FIG. 2, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

FIG. 2 depicts an elevator call control system 200 in an example embodiment. The elevator call control system 200 includes one or more elevator system 101 installed at a building 202. In some embodiments, the building 202 may be a building or a collection of buildings that may or may not be physically located near each other. The building 202 may include any number of floors. Persons entering the building 202 may enter at a lobby floor, or any other floor, and may go to a destination floor via one or more conveyance devices, such as the elevator system 101.

The elevator system 101 may be operably connected to one or more computing devices, such as a system controller 206. The system controller 206 may be configured to control dispatching operations for one or more elevator cars 103 associated with one or more elevator systems 101. It is understood that the elevator system 101 may utilize more than one system controller 206. Although three elevator systems 101 are shown in FIG. 2, it is understood that any number of elevator systems 101 may be utilized. Additional, although each elevator system 101 is illustrated as having one elevator car 103, it is understood that any number of elevators cars 103 may be used each elevator system 101. The elevator cars 103 of FIG. 2 may be referred to also as a first elevator car 103a, a second elevator car 103b, and a third elevator car 103c. It is understood that other components of the elevator system 101 (e.g., drive, counterweight, safeties, etc.) are not depicted for ease of illustration in FIG. 2.

The system controller 206 may include a processor 260, memory 262 and communication module 264, as shown in FIG. 2. The processor 260 can be any type or combination of computer processors, such as a microprocessor, microcontroller, digital signal processor, application specific integrated circuit, programmable logic device, and/or field programmable gate array. The memory 262 is an example of a non-transitory computer readable storage medium tangibly embodied in the system controller 206 including executable instructions stored therein, for instance, as firmware. The communication module 264 may implement one or more communication protocols as described in further detail herein.

Also shown in FIG. 2 is a mobile device 208. The mobile device 208 may be a mobile computing device that is typically carried by a person, such as, for example a smart phone, PDA, smart watch, tablet, laptop, etc. The mobile device 208 may include a touch screen (not shown). The mobile device 208 may include a processor 250, memory 252 and communication module 254 as shown in FIG. 2. The processor 250 can be any type or combination of computer processors, such as a microprocessor, microcontroller, digital signal processor, application specific integrated circuit, programmable logic device, and/or field programmable gate array. The memory 252 is an example of a non-transitory computer readable storage medium tangibly embodied in the mobile device 208 including executable instructions stored therein, for instance, as firmware. The communication module 254 may implement one or more communication protocols as described in further detail herein. The mobile device 208 belongs to a resident or employee of the building 202 who currently has access to the elevator system 101.

Each mobile device 208 may transmit an elevator call 302 to the system controller 206 and the system controller 206 will move an elevator car 103 in response to the elevator call 302. The elevator call 302 may include a “boarding floor” and a “destination floor.” The “boarding floor” is where the person with the mobile device 208 desires to board the elevator car 103 and the “destination floor” is where the person with the mobile device 208 intends to travel. In one embodiment, the elevator call 302 may only include the “destination floor” and the “boarding floor” may be automatically determined by the elevator system 101. Embodiments herein generate a graphical user interface on the mobile device 208 through an application 255. The mobile device 208 may transmit an elevator call 302 through an application 255.

The mobile device 208 and the system controller 206 communicate with one another. For example, the mobile device 208 and the system controller 206 may communicate with one another when proximate to one another (e.g., within a threshold distance). The mobile device 208 and the system controller 206 may communicate over a wireless network, such as 802.11x (WiFi), short-range radio (Bluetooth), cellular, satellite, etc. In some embodiments, the system controller 206 may include, or be associated with (e.g., communicatively coupled to) a networked element, such as kiosk, beacon, hall call fixture, lantern, bridge, router, network node, door lock, elevator control panel, building intercom system, etc. The networked element may communicate with the mobile device 208 using one or more communication protocols or standards. For example, the networked element may communicate with the mobile device 208 using near field communications (NFC). A connection between the mobile device 208 and the system controller 206 may be direct between mobile device 208 and system controller 206 or it may be through a web service. The connection also may include security elements such as VPN or authentication or encryption. In other embodiments, the system controller 206 may establish connection with a mobile device 208 that is inside and/or outside of the building 202 in order to detect a location of the mobile device 208. A location of the mobile device may be determined using various technologies including GPS, triangulation, trilateration, signal strength detection, accelerometer detection, gyroscopic detection, or barometric pressure sensing by way of non-limiting example. The triangulation and trilateration may use various wireless technologies including but not limited to Wi-Fi and Bluetooth. In example embodiments, the mobile device 208 communicates with the system controller 206 over multiple independent wired and/or wireless networks. Embodiments are intended to cover a wide variety of types of communication between the mobile device 208 and system controller 206, and embodiments are not limited to the examples provided in this disclosure. Communication between the mobile device 208 and the system controller 206 will allow the system controller 206 to determine the location of the mobile device 208 in relation to the elevator system 101. The location of the mobile device 208 may be communicated to the system controller 206 through a plurality of sensors 205, discussed further below.

Each elevator system 101 may also include a sensor 205 configured to detect whether a mobile device 208 has entered the elevator car 103. In an embodiment, the sensor 205 may be located on the elevator car 103. The system controller 206 is in electronic communication with each sensor 205 through a wired connection and/or wireless connection. In an alternative embodiment, each sensor may be in indirect communication with the system controller 206 through the mobile device 208. In a non-limiting example, if the sensors 205 are a Bluetooth beacon, then the mobile device 208 can detect when it is in proximity of the sensor 205, then the mobile device 208 can communicate with the system controller 206 that it is in the elevator car 103.

Further, although only one sensor 205 is shown per elevator car 103 for ease of illustration it is understood that each elevator car 103 may contain one or more sensors 205. Each sensor 205 may also be configured to detect operational data of the elevator car 103, such as for example, elevator door position (e.g. open/closed), elevator car location, speed, voltage, vibration, acceleration, noise, deceleration, jerk, and any other performance parameter of any component of the elevator system 103 known to one of skill in the art.

The sensors 205 detect the presence of an individual in an elevator car 103 and identify the individual using various sensing technology, such as, for example Wi-Fi transceivers, Bluetooth transceivers, radio transceivers, visual recognition cameras, people counters, microphones, etc. to detect persons and/or mobile devices entering and leaving the elevator car. The type and nature of sensors 205 within the sensor system 101 is not limited to the embodiments disclosed herein. The mobile device 208 and the sensors 205 communicate with one another. For example, the mobile device 208 and the sensors 205 may communicate with one another when proximate to one another (e.g., within a threshold distance). The mobile device 208 and the sensors 205 may communicate over a wireless network, such as 802.11x (Wi-Fi), ZigBee, Z-Wave and short-range radio (Bluetooth).

In an embodiment, the sensors 205 may include a Wi-Fi transceiver to connect to a mobile device 208 when the mobile device 208 enters the elevator car 103 in order to identify the mobile device 208. In another embodiment, the sensors 205 may include a Bluetooth transceiver to connect to a mobile device 208 when the mobile device 208 enters the elevator car 103 in order to identify the mobile device 208. The sensors 205 are configured to detect a distance between the elevator car 103 and the mobile device 208 to determine whether the mobile device 208 is entering and/or leaving the elevator car 103. The sensors 205 may be configured to detect a distance between the elevator car 103 and the mobile device 208 through wireless signal strength detection.

Communication between the mobile device 208 and the sensors 205 can be one-way or two-way communication. In one example, if Bluetooth is utilized then the mobile device 208 may advertise a Bluetooth signal and the sensors 205 may receive it. In another example, the sensors 205 may advertise a Bluetooth signal and the mobile device 208 may receive it. In another example, there may be two-way Bluetooth communication between the sensors 205 and the mobile device 208. In another example, a Wi-Fi transceiver (i.e. sensor 205) may be placed in an elevator car and the mobile device may detect the Wi-Fi beacon frame as part of the 802.11x protocol as well as the received signal strength of that beacon frame to approximate the distance between the Wi-Fi transceiver and the mobile device 208 but not connect to the Wi-Fi signal. In another example, the mobile device 208 may actively send a probe request looking for Wi-Fi transceivers, then a Wi-Fi transceiver (i.e. sensor 205) located in an elevator car may extract the MAC address of the mobile device 208 from the probe request and approximate distance between the Wi-Fi transceiver and the mobile device 208 from received signal strength.

In another embodiment, the mobile device 208 and the sensors 205 may communicate over a non-radio frequency network. In an example the mobile device 208 and the sensors 205 may communicate through audio transmission, such as, for example a high frequency audio transmission. The mobile device 208 may emit a chirp signature between 15 kHz-20 kHz that one or more microphones (i.e. sensor 205) can detect and extract a signature to determine which mobile device 208 is present. In this example, Audio gain at speaker may be measured to a distance between the microphone and the mobile device 208 may be determined in response to the audio gain. Advantageously, more microphones may help better determine distance. Alternatively, the speakers (i.e. sensors 205) may be located in the elevators car 103 and may emit the high frequency audit for the mobile device 208 to detect. Advantageously, one or more speakers may be help better determine distance.

Referring now to FIG. 3-4 with continued reference to FIGS. 1-2. FIG. 3 shows a flow chart of a method 500 of reassigning an elevator call 302 for an elevator car 103. The method 500 may be performed by system controller 206. FIG. 4 illustrates a mobile device 208 graphical user interface 178. The mobile device 208 may be a laptop computer, smart phone, tablet computer, smart watch, or any other mobile computing device known to one of skill in the art. In the example shown in FIG. 4, the mobile device 208 is a touchscreen smart phone. The mobile device 208 may include a display screen 174 and an input device 50, such as, example, a mouse, a touch screen, a scroll wheel, a scroll ball, a stylus pen, a microphone, a camera, etc. In the example shown in FIG. 4, since the mobile device 208 is a touchscreen smart phone, then the display screen 174 may also function as an input device 50. FIG. 4 illustrate a graphical user interface 178 on the mobile device 208. A user may interact with the graphical user interface 178 through a selection input, such as, for example, a “click”, “touch”, verbal command or any other input to the user interface 178.

At block 504, an elevator call 302 is received from a mobile device 208. The elevator call 302 including a destination request to travel to a destination floor. The destination floor in FIG. 4 is “Floor 27”. At block 506, a first elevator car 103a is assigned to the elevator call 302. An alert may be activated on the mobile device 208 that the first elevator car 103a has been assigned to the elevator call 302, at 402. In FIG. 4, the first elevator car 103a is “Elevator B3”.

At block 508, it is determined that the first elevator car 103a cannot serve the elevator call 302. The alert may be visual, audible, and/or vibratory. As shown in FIG. 4 at 404, the alert may be displayed on the display screen 174 of the mobile device 208. At block 512, it is detected whether the mobile device 208 enters a second elevator car 103b. In one embodiment, the mobile device 208 may be detected by: connecting to the mobile device 208 using at least one of Wi-Fi and Bluetooth; and determining a distance between the second elevator car 103b and the mobile device 208. In another embodiment, the mobile device 208 may be detected by: detecting a wireless signal of the mobile device 208, where the sensor 205 does not connect to the wireless signal; and determining a distance between the second elevator car 103b and the mobile device 208. In another embodiment, the mobile device 208 may be detected by: detecting a beacon transmitted by a sensor 205 proximate the second elevator car 103b using the mobile device 208; and determining a distance between the second elevator car 103b and the mobile device 208 in response to a strength of the beacon. The method 500 may further comprise: determining a boarding floor where the mobile device 208 enters the second elevator car 103b. The boarding floor may be determined by: receiving a boarding floor from a selection input via the mobile device 208 and/or detecting a location of the mobile device 208 when the mobile device enters the second elevator car 103b.

At block 514, the second elevator car 103b is assigned to the elevator call 302. The method 500 may further comprise, moving the second elevator car 103b to the destination floor.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of reassigning an elevator call for an elevator car, the method comprising:
receiving an elevator call from a mobile device, the elevator call including a destination request to travel to a destination floor;
assigning a first elevator car to the elevator call;
determining that the first elevator car cannot serve the elevator call;
activating an alert on the mobile device to enter any elevator car;
detecting whether the mobile device enters a second elevator car; and
assigning the second elevator car to the elevator call.

2. The method of claim 1, wherein prior to determining that the first elevator car cannot serve the elevator call, the method further comprises:
activating an alert on the mobile device that the first elevator car has been assigned to the elevator call.

3. The method of claim 1, wherein the detecting further comprises:
connecting to the mobile device using at least one of Wi-Fi and Bluetooth; and
determining a distance between the second elevator car and the mobile device.

4. The method of claim 1, wherein the detecting further comprises:
detecting a wireless signal of the mobile device, wherein the sensor does not connect to the wireless signal; and
determining a distance between the second elevator car and the mobile device.

5. The method of claim 1, wherein the detecting further comprises:
detecting a beacon transmitted by a sensor proximate the second elevator car using the mobile device; and
determining a distance between the second elevator car and the mobile device in response to a strength of the beacon.

6. The method of claim 1, further comprising:
moving the second elevator car to the destination floor.

7. The method of claim 1, further comprising:
determining a boarding floor where the mobile device enters the second elevator car.

8. The method of claim 7, wherein determining a boarding floor where the mobile device enters the second elevator car further comprises:
receiving a boarding floor from a selection input via the mobile device.

9. The method of claim 7, wherein determining a boarding floor where the mobile device enters the second elevator car further comprises:
detecting a location of the mobile device when the mobile device enters the second elevator car.

10. The method of claim 1, wherein the alert is a message displayed on the mobile device.

11. An elevator system comprising:
a first elevator car;
a second elevator car; and
a system controller comprising:
a processor; and
a memory comprising computer-executable instructions that, when executed by the processor, cause the processor to perform operations, the operations comprising:
receiving an elevator call from a mobile device, the elevator call including a destination request to travel to a destination floor;
assigning a first elevator car to the elevator call;
determining that the first elevator car cannot serve the elevator call;
activating an alert on the mobile device to enter any elevator car;
detecting whether the mobile device enters a second elevator car; and
assigning the second elevator car to the elevator call.

12. The elevator system of claim 11, wherein prior to determining that the first elevator car cannot serve the elevator call, the operations further comprises:
activating an alert on the mobile device that the first elevator car has been assigned to the elevator call.

13. The elevator system of claim 12, wherein the detecting further comprises:
connecting to the mobile device using at least one of Wi-Fi and Bluetooth; and
determining a distance between the second elevator car and the mobile device.

14. The elevator system of claim 12, wherein the detecting further comprises:
detecting a wireless signal of the mobile device, wherein the sensor does not connect to the wireless signal; and
determining a distance between the second elevator car and the mobile device.

15. The elevator system of claim 12, wherein the detecting further comprises:
detecting a beacon transmitted by a sensor proximate the second elevator car using the mobile device; and
determining a distance between the second elevator car and the mobile device in response to a strength of the beacon.

16. The elevator systems of claim 12, wherein the operations further comprise:
moving the second elevator car to the destination floor.

17. A computer program product tangibly embodied on a computer readable medium, the computer program product including instructions that, when executed by a processor, cause the processor to perform operations comprising:
receiving an elevator call from a mobile device, the elevator call including a destination request to travel to a destination floor;
assigning a first elevator car to the elevator call;
determining that the first elevator car cannot serve the elevator call;
activating an alert on the mobile device to enter any elevator car;
detecting whether the mobile device enters a second elevator car; and
assigning the second elevator car to the elevator call.

18. The computer program product of claim 17, wherein prior to determining that the first elevator car cannot serve the elevator call, the operations further comprises:
activating an alert on the mobile device that the first elevator car has been assigned to the elevator call.

19. The computer program product of claim 17, wherein the detecting further comprises:
connecting to the mobile device using at least one of Wi-Fi and Bluetooth; and
determining a distance between the second elevator car and the mobile device.

20. The computer program product system of claim 17, wherein the detecting further comprises:
detecting a wireless signal of the mobile device, wherein the sensor does not connect to the wireless signal; and
determining a distance between the second elevator car and the mobile device.
